(19) United States
(12) Patent Application Publication
(10) Pub. No.: US 2003/0069735 A1
(43) Pub. Date: Apr. 10, 2003

(54) Computerized provision of professional and administrative services

(76) Inventors: Roderic C. E. Butler, Hamilton (BM); Warren Cabral, Paget (BM); David Lines, Pembroke (BM); Roberta Montafia, Warwick (BM); Ruby L. Rawlins, Hamilton Parish (BM); Tammy L. Richardson, Paget (BM)

Correspondence Address: Edward J Radlo, Fenwick & West, Two Palo Alto Square, Palo Alto, CA, 94306, US

(21) Appl. No.: 09/868,821

(22) PCT Filed: Mar. 2, 2001
(86) PCT No.: PCT/US01/06678

(51) Int. Cl. G06F 17/60

(52) U.S. Cl. 705/1; 709/229

(57) ABSTRACT

A system, method, and computer readable medium for providing professional and administrative services to clients (102) via computer, comprising first computing means (103) by which potential clients (101) obtain access to register with the system; second computing means (104),partitioned into a plurality of privated areas, wherein each private area is dedicated to a single client (102), other clients (102) not being granted access to said private area; and third computing means (106) to which the provider (105) of services has access but the clients (102) do not have access. The services may be the formation and organization of a corporation. The invention is most fully described in conjunction with the formation and organization of a Bermuda corporation.

### TECHNICAL FIELD

This invention pertains to the field of service providers_providing professional and administrative services to clients via computer.

### BACKGROUND ART

McHugh, Josh, “Going Offshore on the Internet”, Forbes, Sep. 8, 1997, describes an organization in Anguilla that purportedly uses the Internet to assist in the formation of an Anguillan corporation.

Talev, Margaret, “Same brush has touched opponents”, The Tampa Tribune, Tampa, Fla., Aug. 23, 1998, states that one of the candidates for Secretary of State of Florida “also said she would enable corporations to file their incorporation paperwork over the Internet”.

“Edge: Work-Group Computing Report”, IAC (SM) Newsletter Database (™), EDGE Publishing, U.S.A., Aug. 12, 1996, refers to “Web.LawPartner: Legal & Business Forms Online: Corporate model documents and forms, among other transactional documents.”

“Adobe Systems, Inc. introduces interactive PDF Web forms; Portable Document Format”, Information Today, U.S.A., March 1998, states “IncSpot provides lawyers and paralegals with an on-line library of more than 1,000 corporate forms and 3,000 procedural outlines in Adobe PDF.”

“Software”, Section: Supplement: 1995 Technology Directory, The American Lawyer, March 1995, p.55, U.S.A., mentions at least three companies that provide online services to corporate lawyers.

### DISCLOSURE OF INVENTION

A system, method, and computer readable medium by which a provider (105) provides services to clients (102) via computer, comprising first computing means (103) by which a system. Coupled to the first computing means (103) are second computing means (104) partitioned into a plurality of private areas, wherein each private area is dedicated to a single client (102), other clients (102) not being granted access to said private area. Coupled to the first computing means (103) and to the second computing means (104) are third computing means (106) to which the provider (105) has access but the clients (102) do not have access.

### BRIEF DESCRIPTION OF THE DRAWINGS

These and other more detailed and specific objects and features of the present invention are more fully disclosed in the following specification, reference being had to the accompanying drawings, in which:

FIG. 1 is a general block diagram of the present invention.

FIG. 2 is a block diagram illustrating the principal subcomponents of first computing means 103.

FIG. 3 is a flow diagram illustrating how a user registers with the system.

FIG. 4 is a flow diagram illustrating how registered users 102 log into the system.

FIG. 5 is a block diagram illustrating the principal components of client centre 118.

FIG. 6 is a flow diagram illustrating how a user 102 initiates a process of incorporation.

FIG. 7 is a flow diagram illustrating the second step of incorporation—providing business information.

FIG. 8 is a flow diagram illustrating the third step of incorporation—giving information concerning shared capital.

FIG. 9 is a flow diagram illustrating the forth step of incorporation —providing information concerning the owner.

FIG. 10 is a flow diagram illustrating the fifth step of incorporation—providing information concerning the directors and officers.

FIG. 11 is a flow diagram illustrating the sixth step of incorporation—organisation review.

FIG. 12 is a flow diagram illustrating the process of submitting the completed incorporation questionnaire and paying for the incorporation.

FIG. 13 is a block diagram illustrating components of client centre 118 to which user 102 has access.

FIG. 14 is a block diagram illustrating components of the internal part of the system using the third computing means 106.

FIG. 15 is a flow diagram illustrating how an internal user of the system conducts a search for existing information.

FIG. 16 is a block diagram illustrating the organization of company details 511 stored within the system.

FIG. 17 is a flow diagram showing searches that may be conducted using the quicksearch facility 507 and their results 529, 530, 531, and 532.

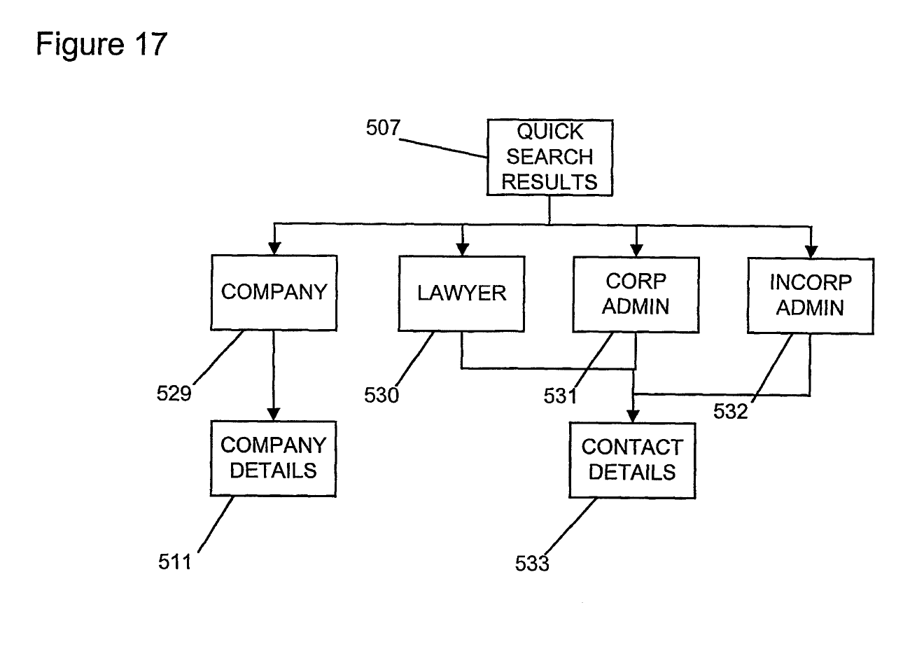

FIG. 18 is a flow diagram of the quicklink facility 207 and the access by the administrator 105 to the company details 210.

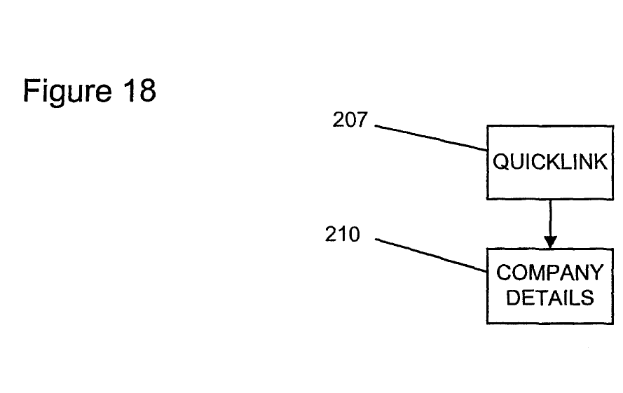

FIG. 19 is a block diagram illustrating components within administrative centre 603 within fourth computing means 602.

FIG. 20 is a block diagram illustrating components within the block of incorporation in Bermuda 610.

### DETAILED DESCRIPTION OF THE PREFERRED EMBODIMENTS

This system can be used to provide many different types of professional and/or administrative services to users 102 who may have no experience in performing the requisite task. It is able to generate all relevant documentation and can calculate and collect any required fee. It performs all these tasks in a secure environment that allows access only to the relevant user 102 and administrator 105. The system streamlines the requisite service by changing it from a task-oriented system to a process-oriented system. This provides significant advantages in quality and efficiency. The specific system detailed in this description is for the incorporation of exempt limited liability companies in Bermuda, but it may be used for many other professional and administrative services.

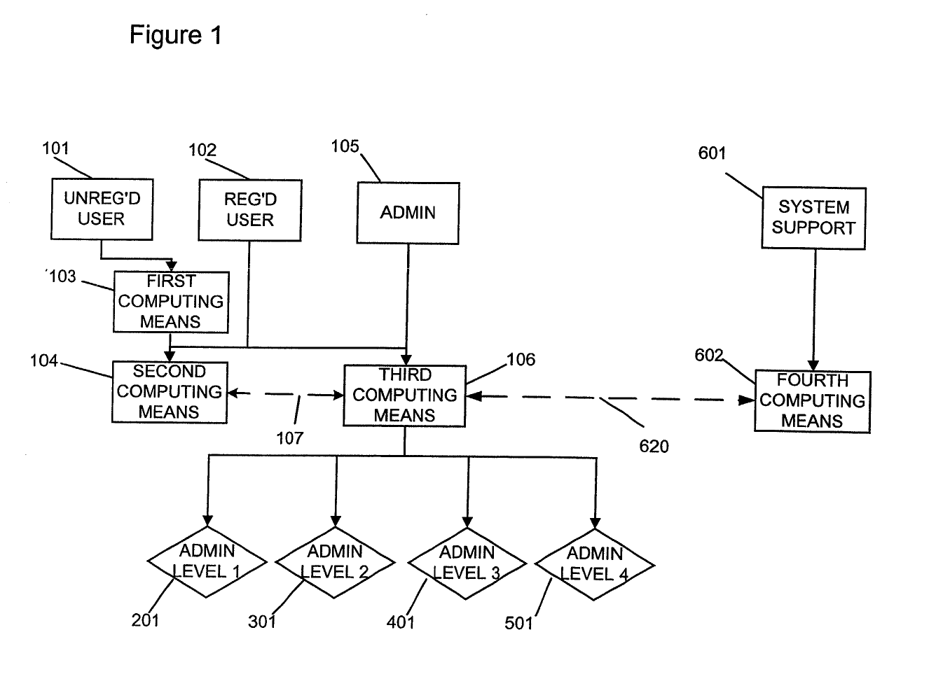

FIG. 1 shows the three different types of user of the system. Unregistered users 101 access the system via the first computing means 103. Registered users 102 can go directly into the second computing means 104 whilst unregistered users 101 must first register through the first computing means 103. Administrator(s) 105 may directly access the third computing means 106 after first having been assigned a user name and password. This is the administrative or internal part of the system. They may also enter the second computing means 104 once they have registered. System support enters the system through the fourth computing means 602.

There is a direct relationship 107, 620 between the various computing means. The user 102 enters data via the first 103 and hence the second 104 computing means. This data is stored in a central database where it may be accessed both by the second computing means 104 and the third computing means 106. The fourth computing means 602 is directly linked to the first 103, second 104, and third 106, computing means. It provides access for support and maintenance of the system by system support 601. The first 103, second 104, third 106, and fourth 602 computing means are linked to each other and are normally hosted on the same computer, but may reside on two or more computers. Access may be made by users 101, 102, administrators 105 and system support 601 online, either through an open or closed network. They may therefore be remote to the computers on which the system is hosted. The operation of the system may also be conducted partly off-line with direct contact between the user 101, 102, administrators 105 and system support 601. The system also provides an automatic e-mail facility, so that at certain specified events, e-mails are sent to users 101,102 and administrators 105.

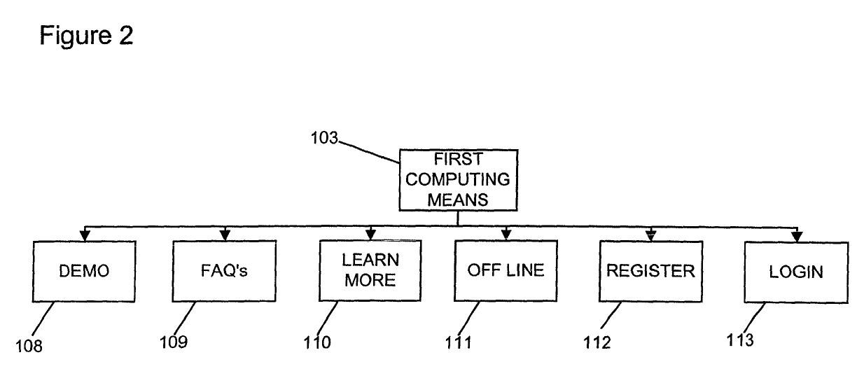

Referring to FIG. 2, the first computing means 103 provides the user 101, 102 with details of the functions provided by the system. Any user 101,102 may access the various public parts ar a demonstration of the system 108, frequently asked questions 109, learn more about the system 110, and off line transactions 111. Users 101 who wish to register in order that they may enter the secure client area at the second computing means 104 may do so via registration module 112. Users 102 already registered on the system may log into the secure client area via log in module 113. For users 101 who do not wish to use the on-line system, an off-line method of incorporation is provided 111. Modules 108-113 may be implemented in hardware, firmware, software, and/or any combination thereof.

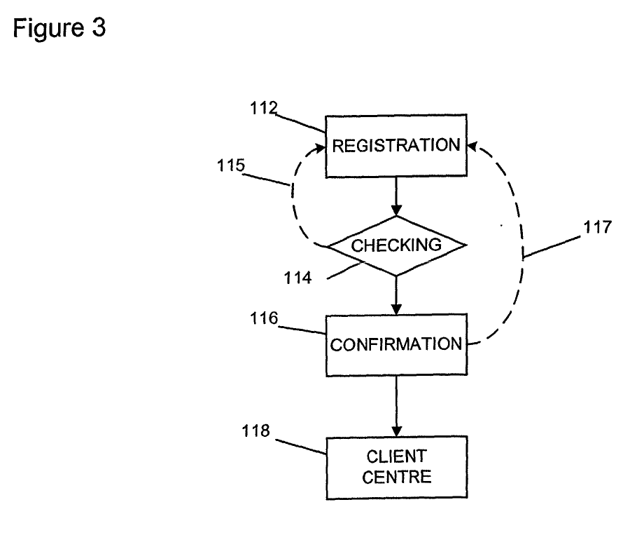

The registration process for access to the secure client centre at the second computing means 104 is shown in FIG. 3. From the first computing means 103, a user 101, 102 is taken to a registration screen 112 and must provide his or her full name and contact details, including the name of any company they may represent. They are also asked to provide a user name and password that must be input twice to ensure that it is correct. A preselected minimum number of letters or alphanumeric characters must be used to ensure a basic level of security. In order to be able to retrieve passwords that ar forgotten, there is also a secret question and secret answer. Certain fields are mandatory and must be completed; these are marked accordingly. Once this data has been input, the user 101 is invited to click on a submit button. After clicking on the submit button, the data is checked at 114 to ensure that the appropriate fields have been completed, the two passwords correspond, and the minimum number of alphanumeric characters have been used for the user name and password. If an error is picked up at this stage, the data is sent back to the user 101 with an error message 115. The user is invited to correct the error and resubmit the data in order for it to be checked again at 114. This process continues until the data is correct. When the data that is submitted is correct, the user 101 is asked for confirmation at 116. At this stage, the user 101 may edit the data by clicking on a button in order to return 117 to the registration screen 112. Otherwise, they may enter the opening screen of the client centre 118.

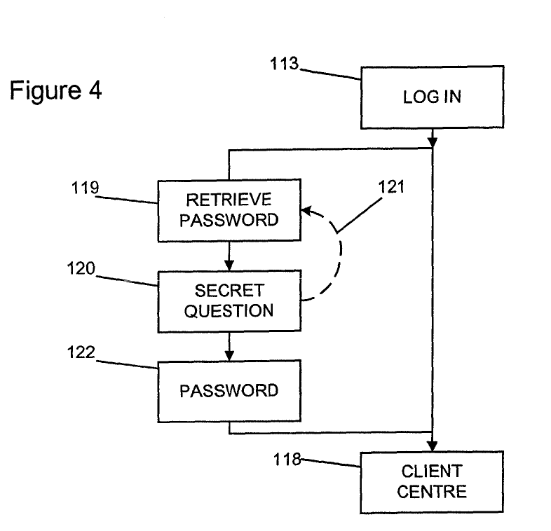

The process for users 102 who have already registered is shown in FIG. 4. Users 102 access the login screen 113 and provide their user name and password. If the password has been forgotten, they may click on a button which takes them to a screen 119 that enables them to retrieve this information. They are asked to provide their user name and e-mail address. Once this is provided, they then click on a button in order to retrieve the password. The next screen 120 provides them with the secret question originally provided during the registration process at 112. If they answer the question incorrectly, they will be asked the question again 121. Once answered correctly, they are provided with their username and password 122. They may then click through to the client centre 118, part of second computing means 104. All through this process, the user is provided with quickhelp and help buttons that they may press for further explanation to be provided.

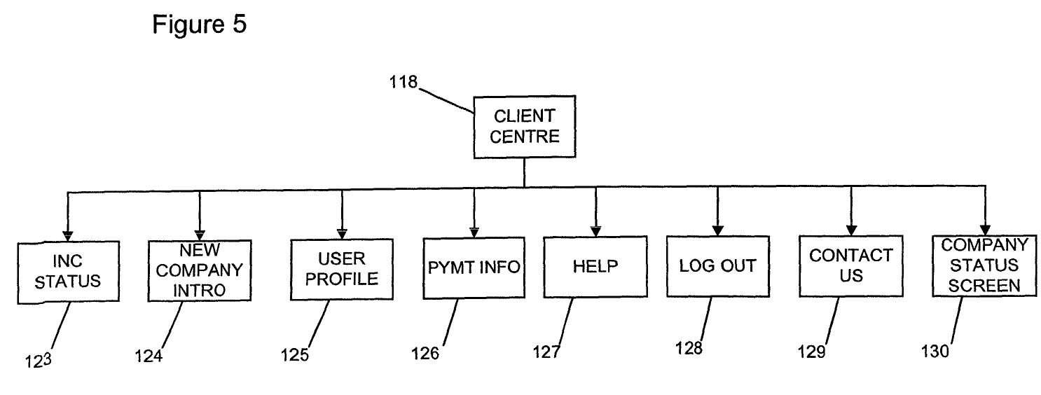

Referring to FIG. 5, the client centre 118 lists for the benefit of the user 102 the names of any companies that the user 102 has started to incorporate using the system and the overall status of that incorporation. This separation of relevant data for each user 101, 102 is enabled due to the client centre 118 being partitioned into a plurality of secure private areas. Each area is distinct to any other and can be accessed only by a user 102 who has the appropriate user name and password. The names of the companies are hypertext links to the incorporation status screen for that particular company 130. The relevant part of the screen will remain blank for first time users 101, as they will not have incorporated any companies. There can be any number of company names that are listed. The client centre 118 also acts as a point of entry to other areas of the secure client centre 118 as well as the outside world. From the client centre 118 the user 102 may access the incorporation status screen 123. This provides the same information as the client centre 118 but is accessible from any part of the secure area. If the user 102 wishes to start a new incorporation, they may access the new company introduction screen 124. The user 102 may check the user profile 125 held by the system and the payment information screen 126 that provides details on payments that the user 102 has made using the system. The client centre 118 also provides the user 102 with general help 127, a log out facility 128, and the opportunity to contact the professional/administrative service supplier 129.

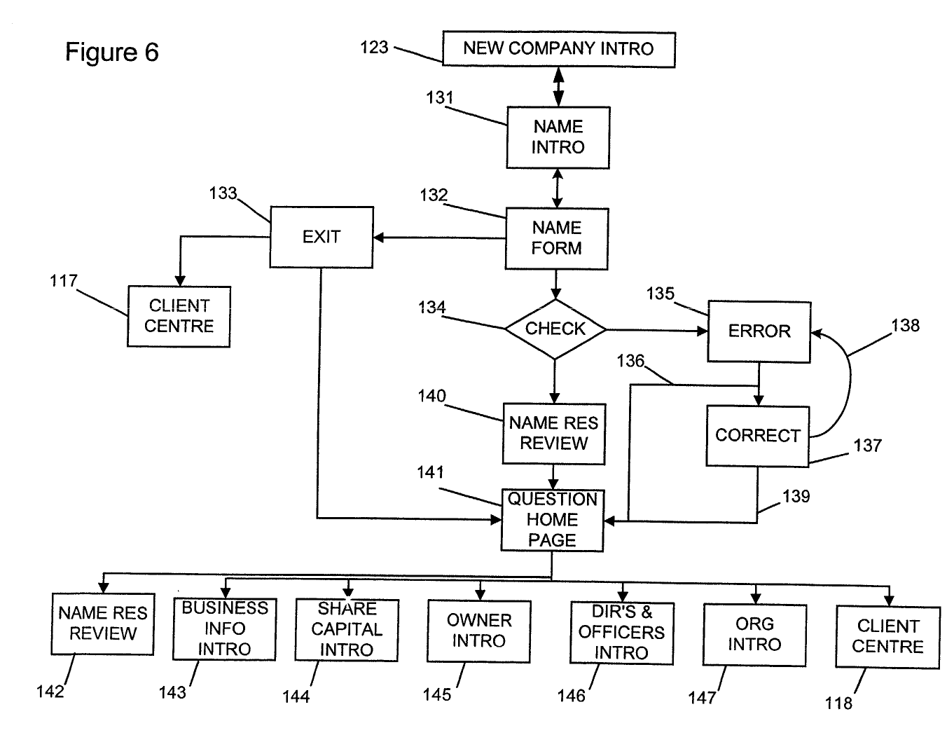

FIG. 6 details the start of the new company incorporation process. The user 102 enters new company introduction 123 from the client centre 118. This provides information about how the system works. From here the user 102 is invited to move to the first of the six steps of incorporation. The six steps are name reservation; business information; share capital; owners; directors and officers; and organisation details. To access these areas the user 102 may click on each hypertext link on the questionnaire home page 141 and will be taken through to name reservation review 142; business information introduction 143; share capital introduction 144; owners introduction 145; directors and officers introduction 146; and organisation introduction 147. From the questionnaire home screen 141, the user 102 may also return to the client centre 118. This first step after the new company introduction 123, however, is name introduction 131. This provides general information about company names and their requirements. After this is the name form 132 for the input of the data. At both name introduction and the name form, the user 102 may return to the previous screen. The user 102 is invited to choose the name of the company that they wish to incorporate and two alternatives. They must also provide the meaning of any initials used and whether there are any other companies registered in Bermuda with a similar name.

If the user 102 has incorporated a company before, they will be asked whether the detail relating to the current incorporation should be copied into this incorporation. At this stage, the user 102 can exit the system 133. This will give them two possible actions: either to go to the questionnaire home page 141 or to the client centre 118. If they remain at the name form 132, once the questions are completed, the user 102 clicks on the next button and the system checks the data to see that relevant responses have been provided 134. In the event that the questions have been answered incorrectly, an error message is created and the user 102 is taken to screen 135. This screen 135 identifies the errors and provides the user 102 with two options. They may ignore the errors 136 and move though to the questionnaire home page 141, where the name status will be shown as “in progress”. Otherwise, they may correct the errors 137 by clicking on the hypertext link for the relevant question that will take them to a screen 137 that will allow the input of the correct answer. Once completed, they will be taken back to the error screen 138 if there are any further errors to correct. If there are not, they will be taken to the questionnaire home screen 141. In the event that the user 102 answered all the questions correctly on the first occasion, the user 102 will be taken from 132 to the review screen 140. If the user 102 is satisfied with the data input, they then click to accept it. This will take them to the questionnaire home page 141 that details the six steps of incorporation with the status of each one. The questionnaire home screen 141 allows the user 102 to control the incorporation process by providing an overview of progress for each of the six steps of incorporation. The steps are listed and the user 102 may click on each one to access the relevant material.

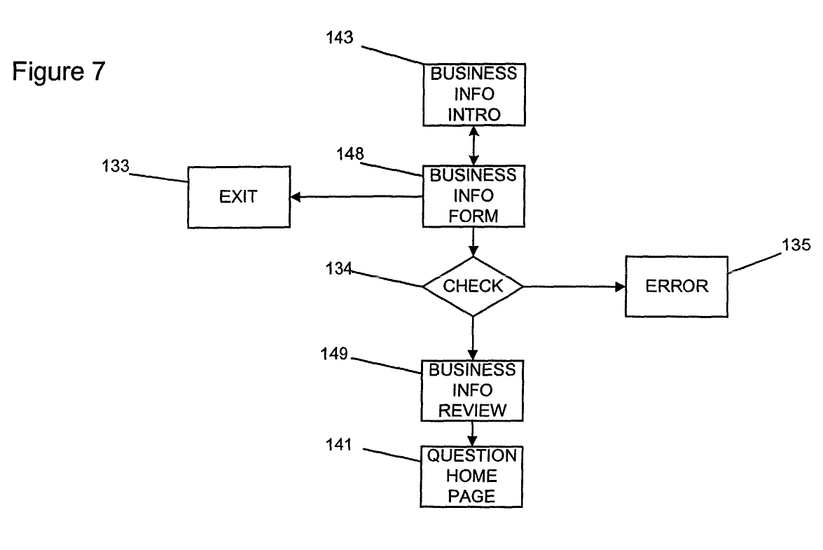

FIG. 7 shows the second step of incorporation—providing business information. By clicking on the relevant hypertext link, the user 102 is taken to business information introduction 143. After this is the business information form 148, which requires input of the relevant data. The form 148 initially requires the user 102 to select from a list of descriptions the intended business of the company. If one of these is selected, the next box is automatically pre-populated with a fuller description. If the business intended by the user 102 is not in the drop-down list, they may complete the next box themselves. At this stage, the user 102 may exit 133 the screen. If they do not do this, then once the questions are completed, the user 102 clicks on the button marked “next” and the system then checks the data to see that relevant responses have been provided 134. In the event that the questions have been answered incorrectly, an error message is created and the user 102 is taken to screen 135. In the event that the user 102 answered all the questions correctly on the first occasion, the user 102 is taken from 148 to the review screen 149. If the user 102 is satisfied with the data input, they then click to accept it. This will take them to the questionnaire home page 141 that details the six steps of incorporation with the status of each one.

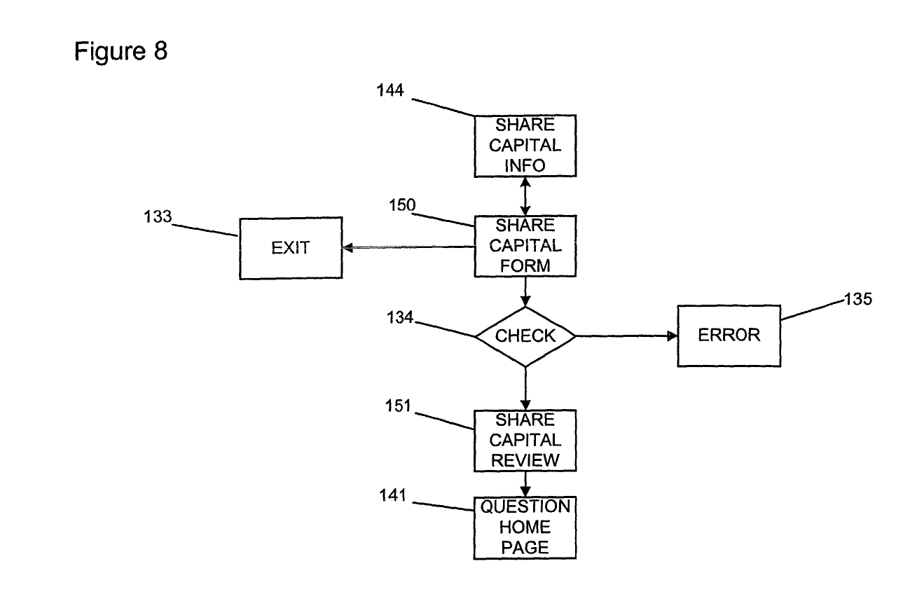

FIG. 8 shows the third step of incorporation—giving information concerning share capital. Share capital information 144 provides an introduction to the user 102. After this is the share capital form 150 requiring input of the relevant data. The form initially requires the user 102 to select the appropriate currency from a pre-determined list. The user 102 must also input the monetary value of the share capital and the par value of the shares. When these are completed, the system then automatically calculates the number of shares available for issue. This is also shown. The user 102 is then asked whether the shares are to be sold at a price higher than par. If the answer is yes, the user 102 is provided with further space where they are requested to provide the amount. The user 102 is required to complete this before moving on. At any stage, the user 102 may exit 133 the screen. If they do not do this, then once the questions are completed, the user 102 clicks on the button marked “next” and the system then checks the data to see that relevant responses have been provided 134. In the event that the questions have been answered incorrectly, an error message is created and the user 102 is taken to screen 135. In the event that the user 102 answered all the questions correctly on the first occasion, the user 102 is taken from 150 to the share capital review 151. If the user 102 is satisfied with the data input, they then click to accept it. This will take them to the questionnaire home page 141 that details the six steps of incorporation with the status of each one.

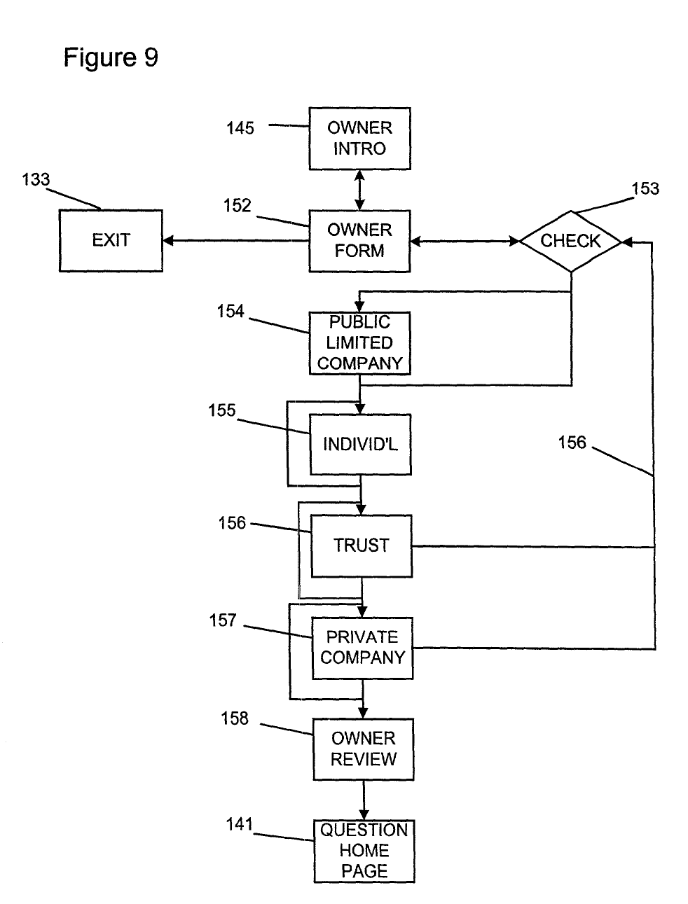

FIG. 9 shows the fourth step of incorporation—providing information concerning the owner. The opening screen 145 provides an introduction to the user 102. After this, the owner form 152 requires the user 102 to list the owner(s) of the company. The name, number of shares and the type of entity must be input. The percentage shareholding of the owner(s) is automatically calculated 152. If there are more owners than available boxes on the screen, the user 102 may add more boxes. Once completed, the user 102 clicks on the “next” button. The system checks the data 153 and if less/more than 100% of the shares are listed by the user 102 as having been taken by the owner(s), the user 102 is then taken back to owner form 152 and an error message is provided. The user 102 must correct this before moving to the next screen. If the data input by the user 102 is correct, then the system selects the appropriate owner type screens to be presented to the user 102. There are four possible types of entity: public limited liability company 154, an individual 155, a trust 156, and a private company 157. Any types of entity not represented by the owner(s) are by-passed. If there is more than one owner of the same type of entity, the relevant screen is provided as many times as are necessary until each owner is dealt with. If the owner of the company being incorporated is a public limited company, the public limited liability screen is provided 154. The user 102 must provide the name of that company, the stock exchange on which it is listed, and the stock ticker symbol. Once completed, the data is checked to ensure that all relevant boxes are completed, and the user 102 is moved to either the next owner type screen 155, 156 or 157, or if the public limited liability company was the only owner, the owner review screen 158. If one or more of the owners was an individual, the user 102 will enter the individual screen 155. Here the user 102 must provide the name and address of the individual and their occupation, nationality and date of birth. As many individual screens will be provided as there are individuals. Once completed, the data is checked to ensure that all relevant boxes are completed, and the user 102 is moved to either the next owner screen 156 or 157, or if the individual(s) was the only owner, the owner review 158. If one or more of the owners was a trust, the user 102 will enter the trust screen 156. The user 102 is required to state the type of trust, the date of settlement, and the country of settlement. The names and entity types of the settlor, trustee(s) and beneficiary(ies) must also be provided, together with a discretionary box that allows the owner to provide additional comments. Once this is done, the user 102 then clicks “next” and is taken through to the entity screens again 154, 155, 156 and 157 in order to provide the relevant information about the settlor, trustee(s), and beneficary(ies).

This process will continue until the ultimate ownership of the trust is provided. Once this has been established, the user 102 will then move through to the last entity type screen for a private company 157, or if there is no other entity type, the owner review screen 158. If one or more of the owners was a private company, the user 102 will enter the private company screen 157. At this screen, the user 102 must provide the place of incorporation and the address of the private company. The screen then requires the user 102 to say whether or not the private company is 100% owned (either directly or not) by one parent entity. If the company is owned by one parent entity, the user 102 clicks on the appropriate button and two additional boxes appear. The user 102 must provide the name of the parent entity and the entity type, and then click on next, and is taken through to the appropriate entity screen (154, 155, 156 or 157) in order to provide the relevant information about the parent entity. Once this has been established, the user 102 will then move through to the owner review 158. If the private company is not owned 100% by a parent entity, the user 102 clicks on the appropriate button and an additional question appears. The user 102 must answer the question whether there are more than 25 shareholders in the private company. If there are, additional boxes appear and the user 102 must provide details of all those people and/or entities who have more than 5% of the ownership. When this information has been provided, the user 102 clicks on next and is taken through to the appropriate entity screen(s) (154, 155, 156 and/or 157) in order to provide the relevant information about the parent entity. Once this has been established, the user 102 will then move through to the owner review 158. If there are not over 25 shareholders, additional boxes appear and the user 102 must provide details of all those people and/or entities. When this information has been provided, the user 102 clicks on next and is taken through to the appropriate entity screen(s) (154, 155, 156 and/or 157) in order to provide the relevant information about the parent entity. Once this has been established, the user 102 will then move through to the owner review 158.

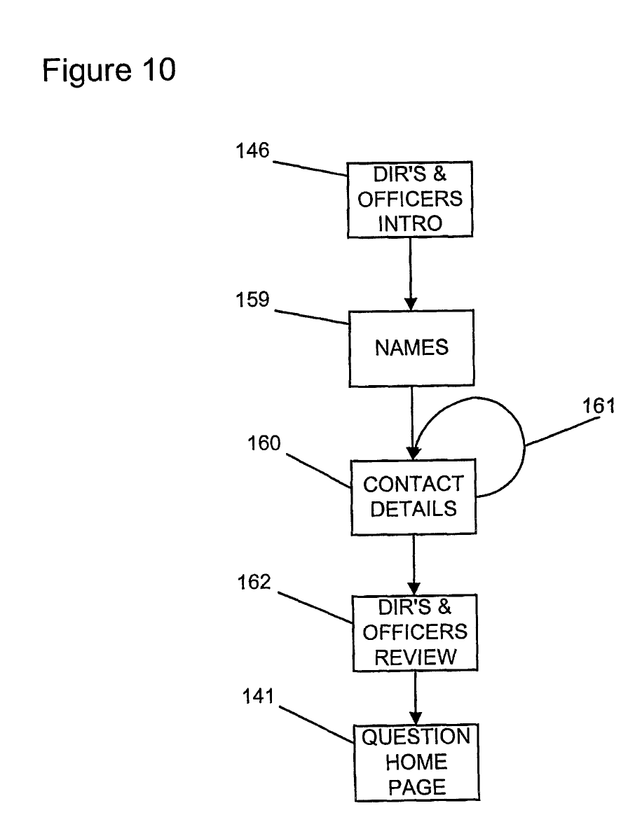

FIG. 10 shows the fifth step of incorporation—providing information concerning directors and officers. From the questionnaire home page 141, the user 102 enters the directors & officers introduction 146. The user 102 is then required to provide the names of the directors, their title, and any officers they wish to appoint 159. The form is prefilled with certain names as part of the service offering. Once completed, the user 102 clicks on the next button and is taken through to a screen 160 where the contact details, occupation and date of birth of the directors & officers are required. This screen will be repeated 161 for as many names the user 102 provided. Once this has been done, the user 102 is taken through to a review 162 where the information that has been input may be reviewed and amended if necessary. The user 102 is then taken through to the questionnaire home screen 141.

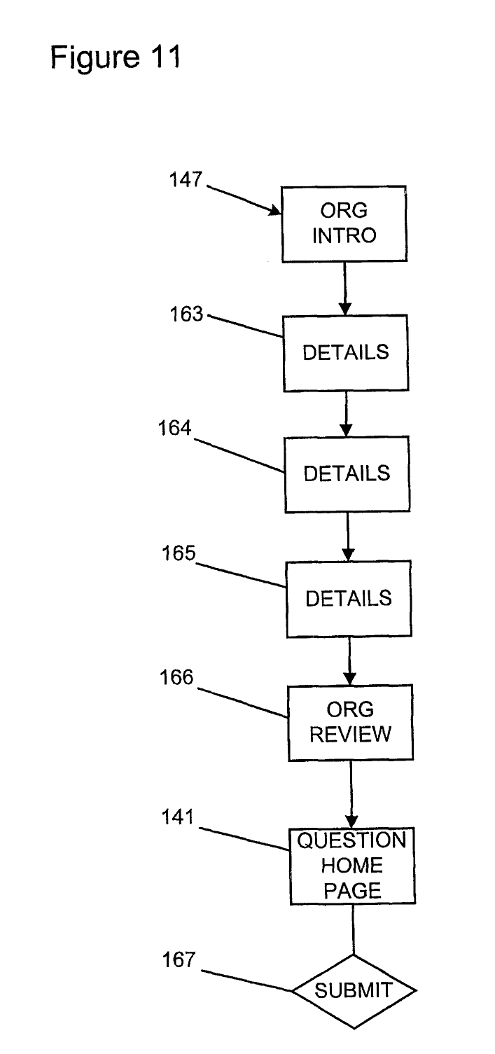

FIG. 11 shows the sixth and final step of incorporation—organisation review. From the questionnaire home page 140, the users 102 enters the organisation introduction 147 and then the first details screen 163. Here the user 102 is asked a variety of questions. Where will the share certificate be held? Will the company establish a business office in Bermuda? Is a Bermuda Bank required? Who is to do the bookkeeping services? Have you selected an auditor? Date of financial year end? First accounting period? Answers may be supplied with either a click box or a text entry box. The user 102 may then go through to the next details screen 164. Here the user 102 is asked for the names and contact details for administration and billing. Once completed, the user 102 clicks on the next button and is taken through to another question screen 165 where the user 102 is asked if they have any further instructions. Once this has been done, the user 102 is taken through to a organisation review 166 where the information that has been input may be reviewed and amended if necessary. The user 102 is then taken through to the questionnaire home screen 141. At this stage, the six questions of incorporation should now be complete. If there are any incomplete questions, the user 102 must access the relevant step and answer the outstanding questions. Once the six steps of incorporation are complete, the user 102 clicks on the submit button 167.

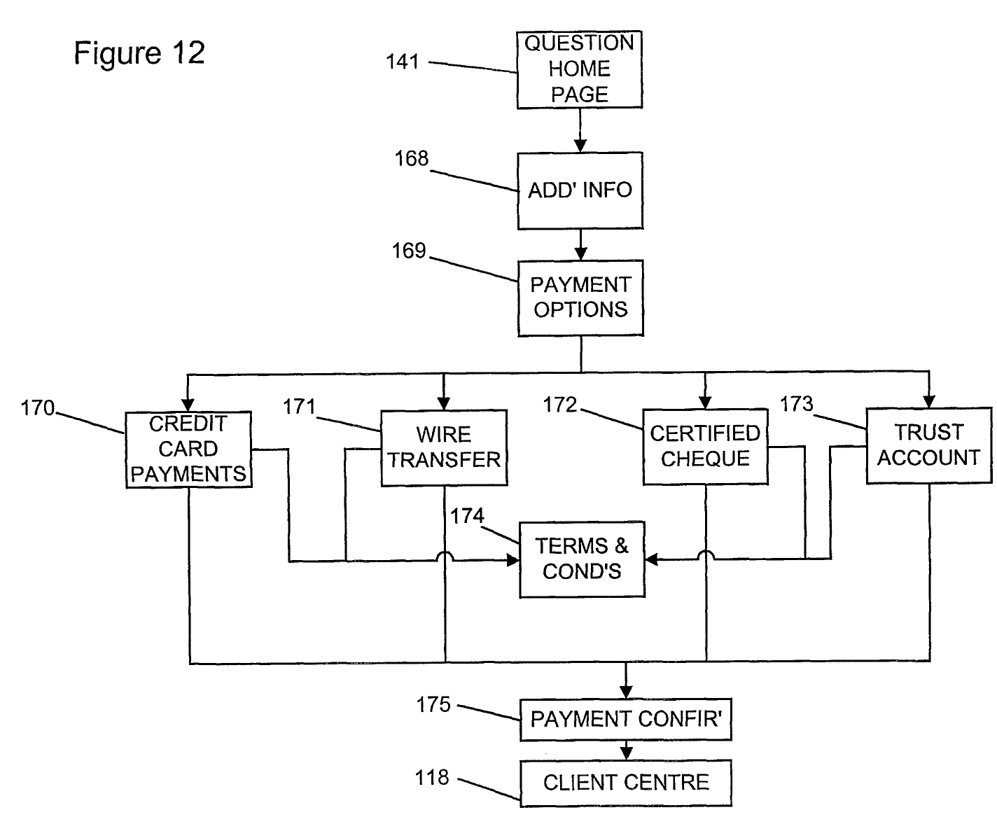

When the user 101, 102 has finished the six steps of incorporation, the questionnaire may then be submitted 167 and the payment process begins as illustrated in FIG. 12. The user 102 is taken to an additional information screen 168. This requests general information as to why the user 102 has incorporated a company in Bermuda; how did it hear of the service; and what did it think of the service? Once these questions have been answered, the user 102 moves through the payment options screen 169. This screen provides the user 102 with the amount due and four different payment options: credit card 170; wire transfer 171; certified cheque 172; and trust account 173. The user 102 selects the appropriate method of payment and is taken through to the respective screen 170, 171, 172, or 173. If credit card payment is chosen, the user 102 is taken to the credit card payments screen 170 that requests the name on the card; the card number; and the expiry date. Once these are completed, the user 102 must click on a box stating that the legal terms and conditions of the service are accepted. The legal terms and conditions are provided on a separate screen 174 that the user 102 may access and the terms include the law that governs the agreement. Once completed, the user 102 is taken to a confirmation page 175 where the relevant data may be checked before final acceptance. After acceptance, the user 102 is taken through to the client centre 118. If wire transfer is chosen, the user 102 is taken to the wire transfer screen 171 that provides the providers full wire transfer details. The user 102 may print this off so that a wire transfer may be completed. Once the details have been noted, the user 102 must click on a box stating that the legal terms and conditions of the service are accepted. The legal terms and conditions are provided on a separate screen 174 that the user 102 may access.

Once completed, the user 102 is taken to a confirmation page 175 where the relevant data may be checked before final acceptance. After acceptance, the user 102 is taken through to the client centre 118. If a certified cheque is chosen, the user 102 is taken to the certified cheque screen 172 that supplies the providers full payment details and address for posting. The user 102 may print this off so that the payment may be completed. Once the details have been noted, the user 102 must click on a box stating that the legal terms and conditions of the service are accepted. The legal terms and conditions are provided on a separate screen 174 that the user 102 may access. Once completed, the user 102 is taken to a confirmation page 175 where the relevant data may be checked before final acceptance. After acceptance, the user 102 is taken through to the client centre 118. If payment from a trust account is chosen, the user 102 is taken to the trust account screen 173 that enables the user 102 to provide the full details of the trust account. This includes the name of the trust; client name; client number; matter name; currency of the trust; and the responsible attorney. Once the details have been noted, the user 102 must click on a box stating that the legal terms and conditions of the service are accepted. The legal terms and conditions are provided on a separate screen 174 that the user 102 may access. Once completed, the user 102 is taken to a confirmation page 175 where the relevant data may be checked before final acceptance. After acceptance, the user 102 is taken through to the client centre 118.

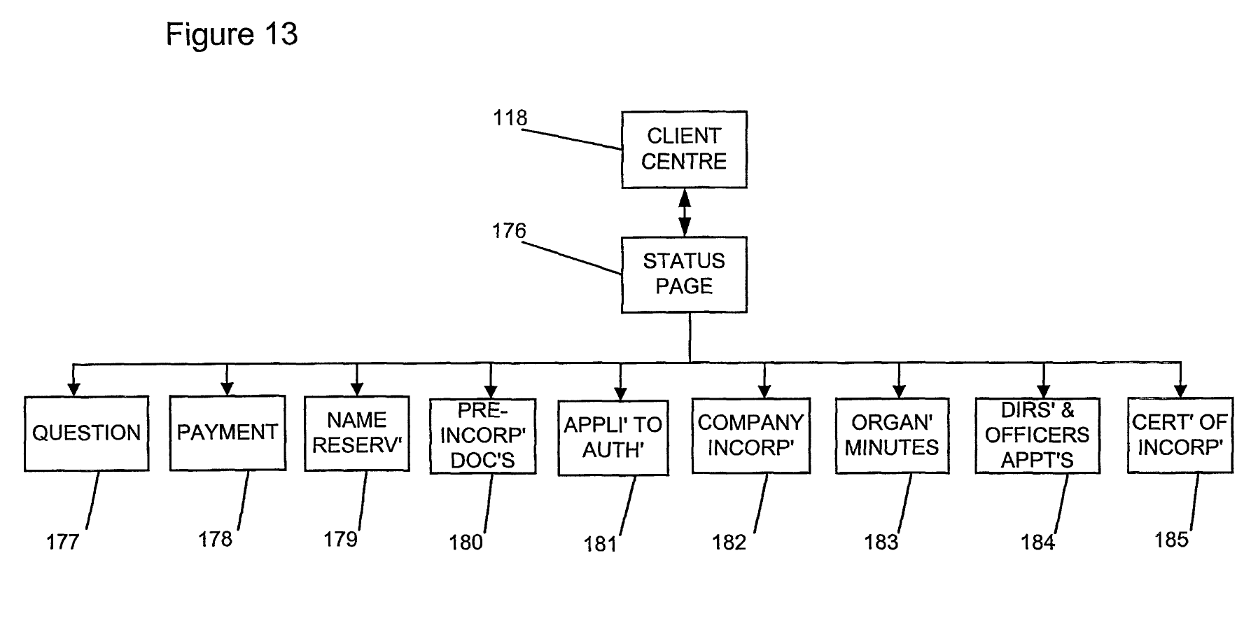

Referring to FIG. 13, when accessing the client centre 118, the user 102 is provided with a list of the companies that he or she has incorporated or is incorporating. The name of each company is a hypertext link through to the status page 176 of the particular company. This provides a list of the various actions that form part of the incorporation process, each of which in turn is a hypertext link through to the status page of that particular action. These are, the questionnaire 177; payment 178; name reservation 179; pre-incorporation documents 180; application to authority 181; company incorporation 182; organisation minutes 183; directors and officers appointments 184; and certificate of incorporation 185. As actions take place, the status is altered so that the user 102 is kept informed of progress. When the user 102 accesses the pre-incorporation documents 180, not only is the status shown, but the various pre-incorporation relevant documents are also provided. The user 102 may click on the document that he/she wishes to view, and the document appears on screen. The documents are in a particular format that allows the user 102 access, and they may print them off, but they cannot alter them.

At all times during the registration process, the user 102 may access the system to find out the latest information relating to any incorporation that they have access to. This information is provided at the client centre 118. This is the case whether the information for the incorporation is input directly by the user 102 or is conducted offline 111 through the use of a written questionnaire that is sent to the system provider for input by an administrator. At all times, the status of the various stages of the incorporation is updated to reflect current events by the relevant administrator.

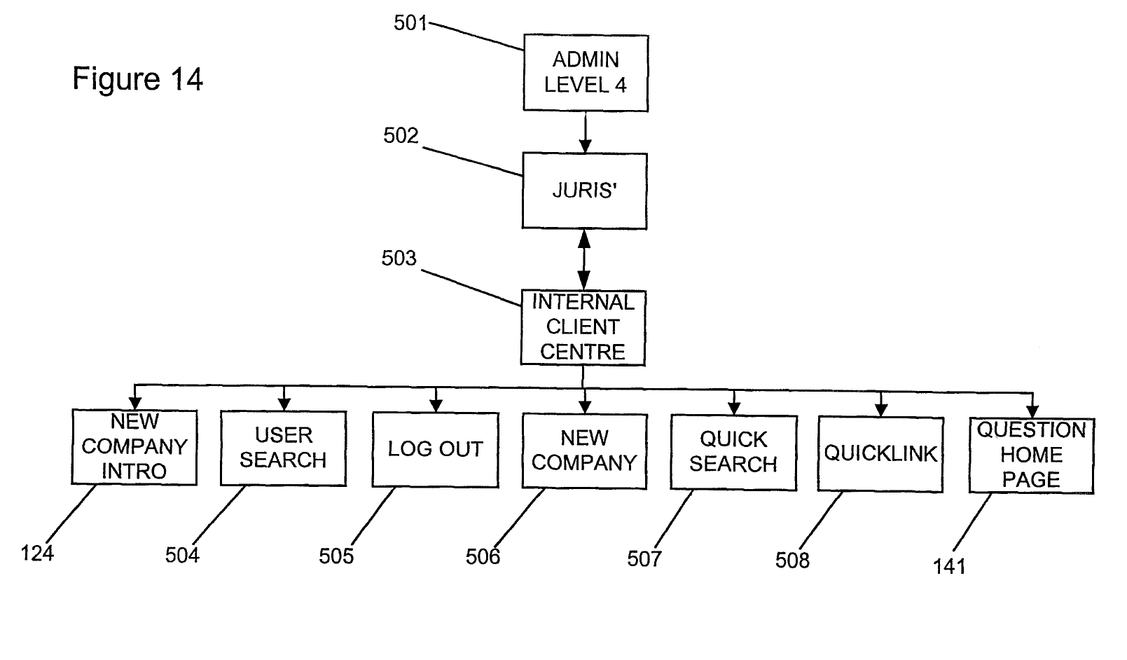

FIG. 14 shows the opening screens for the internal part of the system 106, 602. The administrator level 4 501 accesses the internal part of the system through the third computing means 106. As the system may be multi-jurisdictional, once having entered the system, the administrator level 4 501 is provided with access to those jurisdictions for which he/she has access 502. Once the jurisdiction is chosen, the administrator level 4 501 is taken to the internal client centre 503. The internal client centre 503 provides the administrator level 4 501 with a number of choices. These are: new company introduction 124; user search 504; log out 505; new company 506; quick search 507; quick link 508; and questionnaire home page 141.

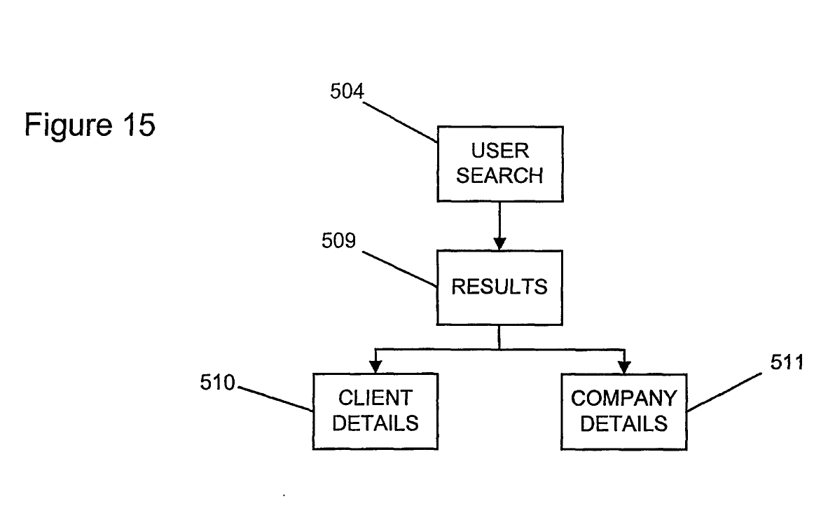

If the administrator level 4 501 wishes to create a new company, he/she clicks on the relevant hypertext link and is taken through to the equivalent page within the internal site to the external new company introduction screen 124. The incorporation process for a new company is the same in the internal part of the system 106, 602 as for the external system 103, 104. The administrator level 4 501 may access a user search facility 504. Referring to FIG. 15, this enables a search to be made using the first and last names of the users 102 of the system and the name of any companies incorporated using the system. By clicking on the link, the administrator level 4 501 is taken to a screen 504 that allows the required search to be made. Upon the search having been done, a screen appears providing the results 509. The results are a list detailing the client name(s), the client number(s) and the name of the company(ies) that is/are incorporated. The client name(s) and company(ies) incorporated are hypertext links through to the client details 510 and company details 511, respectively. Referring back to FIG. 14, the administrator level 4 501 may log out of the system 505. Links are provided to new companies so that the status of payment may be noted 506. Once the payment has been input, the status changes and the administrator is returned to the internal client centre 503. If part payment is made, this is reflected in the status, and the administrator may return to record a further payment 506 until the total due is received. A quick search may be performed 507. The administrator level 4 501 inputs the details to be searched and then must select the search type. The search type may be the company; business type; client number; lawyer; corporate administrator; or id administrator. Upon the search having been carried out, the results are listed 507 with the company name; the lawyer; the corporate administrator and the incorporation administrator. These are all hypertext links. The company link takes you through to the company details 511.

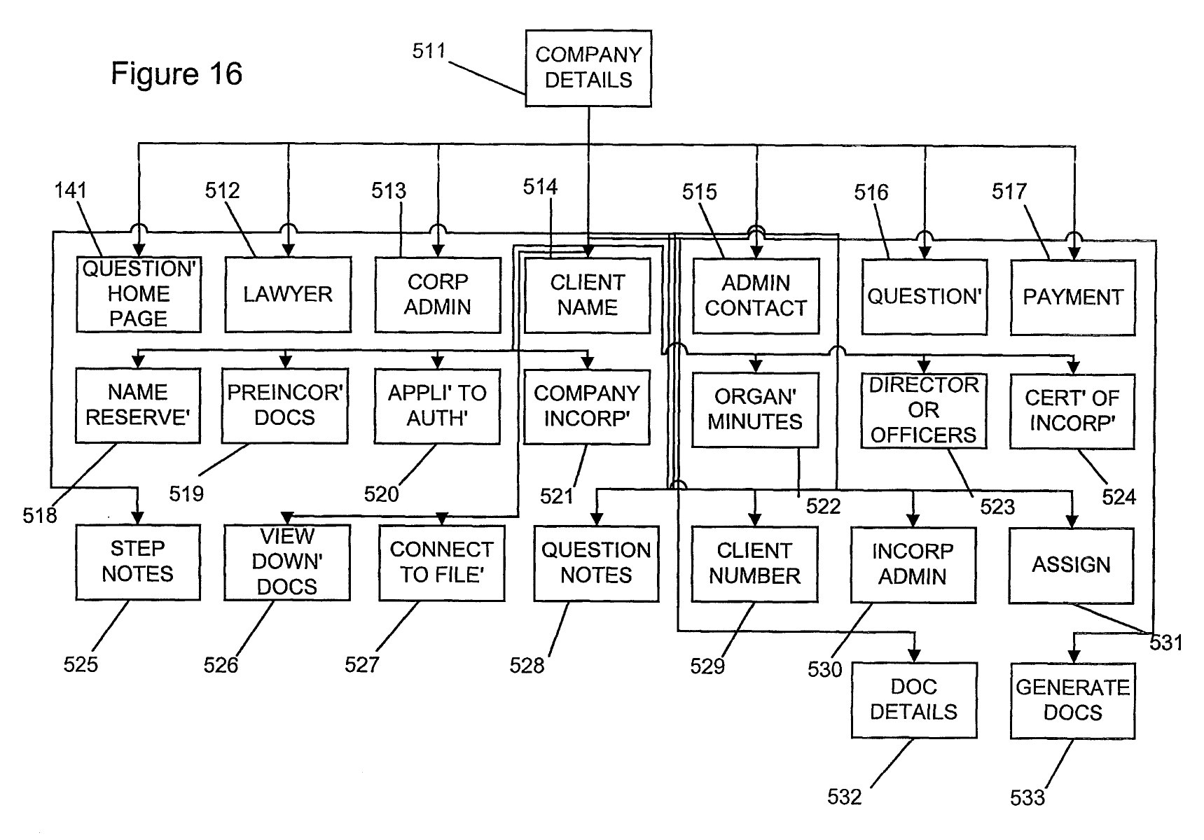

Referring to FIG. 16, from the company details 511 the administrator level 4 may access a wide variety of information. The lawyer 512; the corporate administrator 513; client name 514; administrative contact 515; and the incorporation administrator 530 all take you through to the contact details of the respective parties. The client number 529 allows the administrator level 4 501 to assign a reference number to the client for accounting purposes. Assignment 531 takes the administrator level 4 501 to a screen 531 where the id administrator; lawyer; document administrator; document lawyer 1 and document lawyer 2 may be appointed. There is also a facility whereby the administrator level 4 501 may click on a tick box so that the system automatically sends an e-mail to the id administrator, lawyer and document administrator. Company details 511 also provides access to information provided by the external questionnaire home page 141 with links through to the relevant screens—name reservation; business information; share capital; owner; directors and officers; and organisation. The administrator level 4 501 may also add notes to each of these screens. The administrator level 4 501 may also review the questionnaire notes 528 which are a compilation of all the notes from the question screens. Upon the administrator level 4 501 clicking on the relevant hypertext link, the company details 511 also provide contact details for the lawyer 512; corporate administrator 513; and client 514. The company details 511 provide status pages for the nine internal steps of incorporation. These are the questionnaire 516; payment 517; name reservation 518; preincorporation documents 519; application to authority 520; company incorporated 521; organisational minutes 522; directors or officers 523; and certificate of incorporation 524. There are also step notes 525 that are notes input by administrator level 4 501 referring to the company that is being incorporated. The company details 511 also provide access to view downloadable documents 526 and connect to fileserver 527. The view downloadable documents screen 526 allows the administrator level 4 501 to view various preincorporation documents that have been created by the system. These are in a particular format that allows the user 102 access and they may print them off, but they cannot alter them.

The administrator level 4 501 may both access and alter the documents. The administrator level 4 501 clicks on the document that he/she wishes to view and the document appears on screen. Connect to fileserver 527 allows the administrator level 4 501 to view all other documents that the system produces. The administrator level 4 501 may also generate documents 533. By clicking on this facility, the administrator level 4 501 is taken through to a screen with a list of documents that all have click boxes. By clicking on the click boxes, the administrator level 4 501 identifies the documents for the system to produce. Once this has been done, the administrator level 4 501 clicks on the submit button and is returned to company details 511 whilst the system prints the documents. The administrator level 4 501 may also provide the document details 532. These are the date of incorporation and the date of the statutory meeting. By clicking on the document details hypertext link, the administrator level 4 501 is taken to a screen, where the date of incorporation and the date of the statutory meeting may be provided. After inputting the data, the administrator level 4 501 is taken back to the company details screen 511.

Referring to FIG. 14, quicklink 508 lists the companies that have been assigned to the administrator level 4 501. Upon clicking on the company names, the administrator level 4 501 is taken through to the company details 511. The administrator level 4 501 may also access the questionnaire home pages 141 for any companies that they begun to incorporate. Such companies are listed as hypertext links through to those questionnaire home pages 141.

The system provides different levels of access to administrators. This provides flexibility and security so that various parties may view those parts of the site relevant to them whilst others may change data and operate the system. Administrator level 4 501 has access to all parts of the system and may alter data and assign tasks. Administrator level 1 201 has the same access as administrator level 4 501 save that he/she may not write notes, assign tasks 531, generate documents 533, input a client number 529, or provide document details 532. An administrator level 2 301 has the same access as administrator level 4 501 save that he/she may not generate documents 533 or assign tasks 531. An administrator level 3 401 has the same access as administrator level 4 501 save that he/she may not assign tasks 531.

Referring to FIG. 1, the system requires support and maintenance. System support 601 is provided through the fourth computing means 602. Access is through a screen 602 that requires the input of a user name and password. There is a direct relationship 620 between the fourth computing means 602 and the third computing means 106.

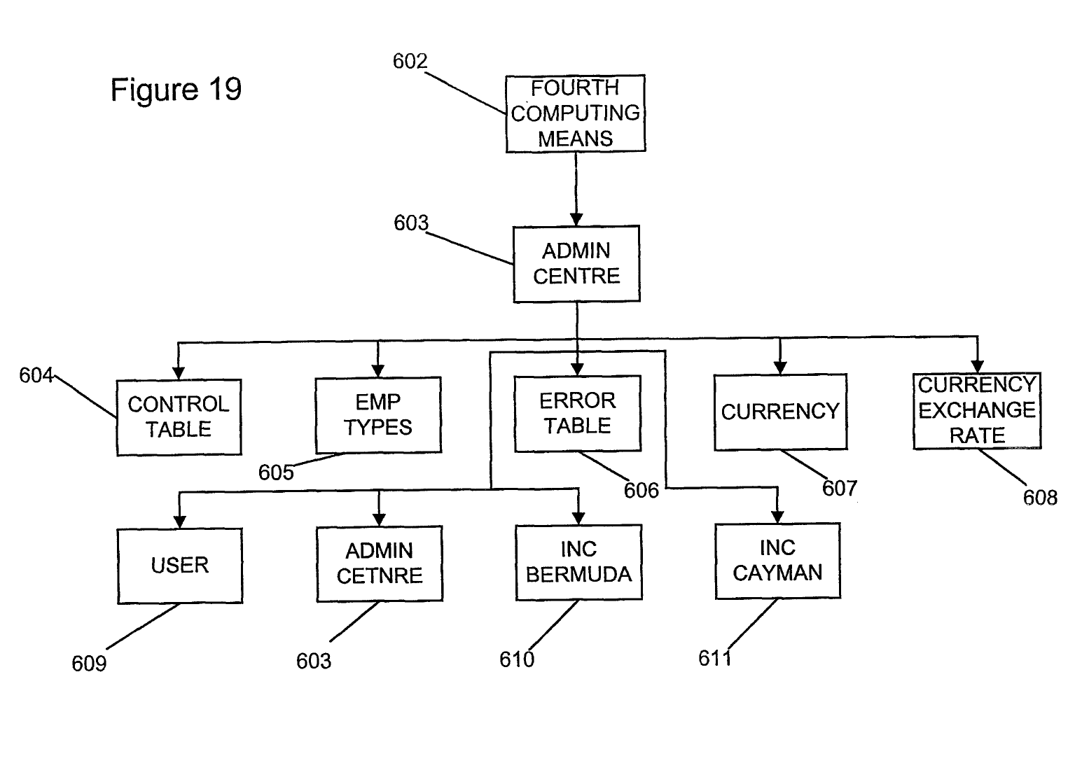

Upon system support 601 having entered the secure area through the fourth computing means 602, they enter an administration centre 603 as illustrated in FIG. 19. The administration centre 603 is a secure area, but unlike the third computing means 106, it is not split into plurality of private areas. The fourth computing means 602 allows system support 601 to alter data throughout the system, both in the internal and external parts of the system. This enables, for example, fees to be changed or new system users 102 to be added. The administration centre 603 has a number of hypertext links that allow the system support 601 to access various parts of the secure area. These are control table 604; employee types 605; error table 606; currency 607; currency exchange rate 608; user 609; administration centre 603; incorporation Bermuda 610; and incorporation Cayman 611. In order to access these various areas of the fourth computing means 602, system support 601 clicks on the respective hypertext links at the administration centre 603. When accessing control table 604, employee type 605, error table 606, currency 607 and currency exchange rate 608, system support 601 is provided with the means to alter the respective data for those particular screens. Once amended, system support 601 is taken back to the administration centre 603. When system support 601 clicks on the hypertext link for user and is taken through to the user screen 609, he/she is provided with a search facility in order to find relative data for each particular user. There is also the facility to add users to the system. If the system support 601 wishes to add a new user, the relevant button is clicked and new boxes appear which enable the data to be input. Upon finishing at the user screen 609, system support 601 is taken back to the administration centre 603. The fourth computing means 602 may also provide access to linked systems that provide the same service in other areas or jurisdictions.

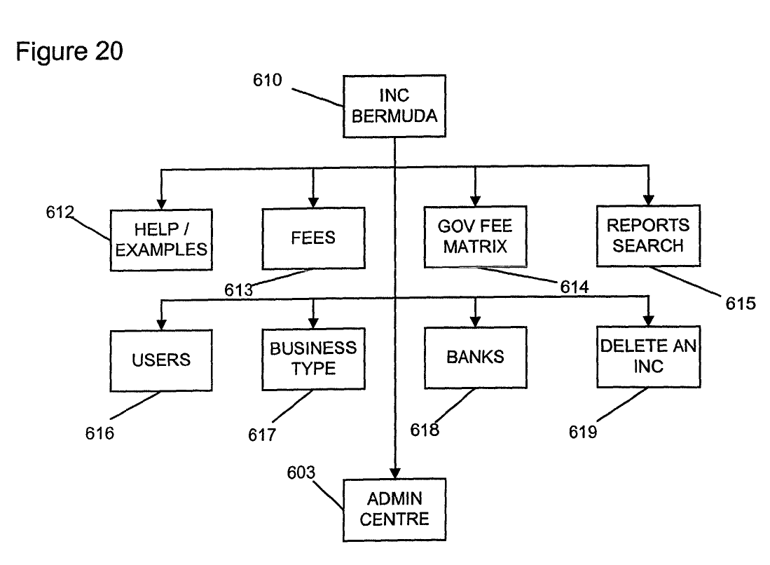

On the current system that is being described, incorporations may take place in various jurisdictions. Therefore, at the administration centre 603, system support 601 is provided with the opportunity of accessing the pertinent data for the various jurisdictions. In the current system being described, these are incorporation in Bermuda 610 and incorporation in the Cayman Islands 611. By clicking on the respective hypertext links for those two jurisdictions, the system support 601 is taken through to the respective screens which are incorporation in Bermuda 610 and incorporation in the Cayman Islands 611. From here, they are provided with several hypertext links that provide them with access to the respective data for that particular jurisdiction. Therefore, as illustrated in FIG. 20, system support 601 that accesses incorporation Bermuda 610 is provided with hypertext links to help/examples 612; fees 613; government fee matrix 614; reports search 615; users 616; business type 617; banks 618; and delete an incorporation 619. Access by system support 601 to help/examples 612, fees 613, government fee matrix 614 and business type 617, takes the system support 601 to the relevant screens where they may alter the respective data. Once completed, they are then taken back to incorporation Bermuda 610. When system support 601 accesses reports search 615, they are provided with the ability to perform a search for financial reports. This permits them to put in various dates, and the system will calculate the reports that are to be produced. Once completed, system support 601 is then taken back to incorporation Bermuda 610. When system support 601 accesses users 616, they are provided with the facility for searching each individual user and also to add new users to the system. When the system support 601 adds a new user, they also state the access level. Upon finishing at this screen, system support 601 is taken back to incorporation Bermuda 610. When system support 601 accesses delete incorporation 619, system support 601 is provided with the ability to click on a particular incorporation from pre-selected lists of all the incorporations on that part of the system and to delete that incorporation. Upon their finishing at this screen, they are then taken back to incorporation Bermuda 610. At all stages, the system support 601 is provided with a link back to the administration centre 603.

The following are some examples of e-mails that are issued by the service provider pursuant to the present invention.

Thank you for submitting an Incorporation for Just AS&K Inc.

Once your questionnaire has been approved we will e-mail you a list of client deliverables.

Sincerely,

Appelby Spurling & Kempe

Dear <<ClientName>>,

RE: <<IncName>>

Your Questionnaire has been approved and we are proceeding with the incorporation of the company. Before we can submit the application to the Bermuda Authorities for approval, you are required to sign, have witnessed (where indicated) and return the following documentation:

Personal Declarations

Share holders Proxy

Subscription Sheet

Consent to Short Notice

These documents are available for downloading online from your Secure Client Centre and must be downloaded in Adobe PDF format. Each document file will contain completion and submission instructions. To download the document, follow these simple steps:

1. Connect to the Internet

2. Go to https://scc.ask.bm/_mem_bin/FormsLogin.asp

3. Enter your login and password (created when you registered)

4. Click on <<IncName>> in your companies list

5. Click on Required Preincorporation Documents in your Incorporation Status List

6. The documents available for download are listed at the bottom of the page

In order to expedite your incorporation you will need to return the above documents to our office by facsimile at 441-295-0787 as soon as +OSSIBLE, or you may send them by overnight express to:

Incorporations Department, Cedar House, 41 Cedar Avenue, Hamilton HM 12, Bermuda.

Sincerely

Incorporations Department

Appleby Spurling & Kempe

-----

Do you have questions about the status of your incorporation?Visit the web site (http://www.justaskinc.bm). We will be updating you on the status of your incorporation online. Just Login and click on the name of the new company you are incorporating for an updated status report.

From: Customer Service (justaskinc@ask.bm)

Sub: Update for <<IncName>> (<<WebClientNumber>>)

0---------Maximum width, 70 characters----------0

Dear <<ClientName>>

RE: <<IncName>>

Your Questionnaire has been reviewed and we are proceeding with the incorporation of <<IncName>>. Before we can submit the application to the Bermuda Authorities for approval, you are required to sign, have witnessed (where indicated) and return the following documentation:

Personal Declarations

Shareholders Proxy

Subscription Sheet

Short Notice

The documents are available for download online from your Secure Client Centre. The documents are ready for download in Adobe PDF format and each document file will contain completion and submission instructions. To download the document, follow these simple steps:

1. Connect to the Internet

2. Go to http://www.justaskinc.bn/login.asp

3. Enter your login and password (created when you registered)

4. Click on <<IncName>> in your companies list

5. The documents available for download are listed at the bottom of the page

In order to expedite your incorporation you will need to return the above documents to our office as soon as possible.

Sincerely

Incorporations Department

Appleby Spurling & Kempe

-----

Do you have questions about the status of your incorporation? Visit the web site (http://www.justaskinc.com). We will be updating you on the status of your incorporation online. Just Login and click on the name of the new company you are incorporating for an updated status report.

Dear <<ClientName>>,

Thank you for using Just AS&K [Inc] to incorporate your Bermuda company. We will begin the process of incorporating your company once your payment has been received.

According to our records, you have selected to pay by way of <<PaymentMethod>> for the incorporation of <<IncName>>. The cost of incorporation is <<AmountToBePaid>> USD.

Please note that the incorporation process is dependent on the Bermuda Authorities who carefully vet all applications. The incorporation process is usually completed within 2-3 working days of submission to the Bermuda Authorities.

If you have any questions, or require further assistance in remitting your payment, please contact us at justaskinc@ask.bm.

Sincerely,

Incorporations Department

Appleby Spurling & Kempe

Dear <<ClientName>>,

Thank you for using Just AS&K [Inc] to incorporate your Bermuda company. We will begin the process of incorporating your company once payment has been verified.

According to our records, you have selected to pay ulilising funds currently held in an existing trust account for the incorporation of <<IncName>>. The cost of incorporation is <<AmountToBePaid>> USD.

For your protection, our accounting department may require further information or verbal authorisation prior to the use of the trust funds.

Please note that the incorporation process is dependent on the Bermuda Authorities who carefully vet all applications. The incorporation process is usually completed within 2-3 working days of submission to the Bermuda Authorities.

Sincerely,

Incorporations Department

Appleby Spurling & Kempe

Dear <<Client Name>>,

This message is to notify you that your payment for the incorporation of <<Inc_Name>> has not been received yet.

Sincerely,

Appelby Spurling & Kempe

Dear <<Client Name>>,

Thank you, your payment for the incorporation of <<Inc_Name>> has been received. We will be e-mailing a list of client deliverables soon.

Sincerely,

Appelby Spurling & Kempe

Dear <<ClientName>>,

Thank you. Your “+21`<PaymentMethod>>” payment for the incorporation of <<IncName>> has been received and the incorporation process has begun!

Once your Questionnaire has been approved by our Incorporation Team for submission to the Bermuda Authorities, you will receive documents that will require your immediate attention. Please watch for another e-mail arriving in the next day or so with more information.

Please note that the incorporation process is dependent on the Bermuda Authorities who carefully vet all applications. The incorporation process is usually completed within 2-3 working days of submission to the Bermuda Authorities.

Sincerely

Incorporations Department

Appleby Spurling & Kempe

-----

Do you have questions about the status of your incorporation? Visit the web site (http://www.justaskinc.bm). We will be updating the status of your incorporation online. Just Login and click on the name of the new company you are incorporating for an updated status report.

Dear <<ClientName>>,

According to our records, payment has not yet been received for the incorporation of <<IncName>>. Upon submission of the Questionnaire, you chose to pay by way of <<PaymentMethod>>. The cost of incorporation is <<AmountToBePaid>> USD.

To ensure your payment is correctly received, please reply to this e-mail with any additional payment details you can provide (such as the date payment was sent, the amount, etc.).

If you have already submitted your payment, please accept our thanks and disregard this e-mail.

If you have any queations, or require further assistance in remitting your payment, please contact us at justaskinc@ask.bm.

Sincerely,

Incorporations Department

Appleby Spurling & Kempe

Dear <<ClientName>>,

We are pleased to confirm that <<IncName>> was successfully incorporated on <<IncDate>>.

Before <<IncName>> can transact any business, the organisational stage of the incorporation process needs to be completed in full. Another e-mail will be arriving in the next day or so to provide you with more information.

Sincerely

Incorporation Department

Appleby Spurling & Kempe

-----

Do you have questions about the status of your incorporation? Visit the Just AS&K [Inc] web site (http://www.justaskinc.bm). We will update the status of your incorporation online. Just Login and click on the name of the new company you are incorporating for an updated status report.

Dear <<ClientName>>,

We are pleased to confirm that the incorporation and organisation process is complete and <<IncName>> can now transact business.

Please be advised that the records and files of <<IncName>> are under the administration of the assigned A.S. & K. Services Ltd. Corporate Administrator, <<CorpAdmin>>, to whom all future communications should now be referred.

Once again thank you for using Just AS&K [Inc].

Sincerely

Incorporations Department

Appleby Spurling & Kempe

Please note, you can now copy and amend the information in the <<IncName>> Questionnaire for any future incorporation. This will greatly speed up the process. You can also return to the Just AS&K [Inc] web site (http://www.justaskinc.bm) to review the <<IncName>> Questionnaire and to down load any documents created during the incorporation process.

List of Client Deliverables

RE: <<Inc_Name>>

We are proceeding with the organisation of the above named Company and have available the following documentation on your Secure Client Centre for signature and return:

Personal Declarations

Shareholders Proxy

Subscription Sheet

Short Notice

It would be appreciated if you could arrange to have the above-mentioned documents signed and witnessed, where indicated, and returned to this office as soon as possible.

Your faithfully,

APPLEBY SPURLING & KEMPE

[image]

1. A system by which a provider provides services to clients via computer, said system comprising:
first computing means by which a potential client obtains access to register with the system;
coupled to the first computing means, second computing means partitioned into a plurality of private areas, wherein each private area is dedicated to a single client, other clients not being granted access to said private area; and
coupled to the first computing means and to the second computing means, third computing means to which the provider

2. The system of claim 1 wherein the services are legal services.

3. The system of claim 1 wherein the second computing means and the third computing means are part of the same computer.

4. The system of claim 1 wherein the client accesses the first computing means in an online manner.

5. The system of claim 4 wherein the client accesses the first computing means via an open network.

6. The system claim 1 wherein the client accesses the first computing means in an offline manner.

7. The system of claim wherein the client is remote from at least one of said computing means.

8. The system of claim 1 wherein the provision of services is the formation and organization of a corporation.

9. The system of claim 8 wherein the incorporation is formed according to the laws of Bermuda.

10. The system of claim 1 wherein the first computing means performs at least one of the following functions:
gives answers to frequently asked questions;
allows the client to register with the system;
allows the client to log into the system;
gives the client a demonstration of the system;
allows the client to learn more about the system;
allows the client to download a registration questionnaire;
allows the client to send an e-mail to the provider.

11. The system of claim 1 wherein the second computing means performs at least one of the following functions:
allows the client to fill out a registration questionnaire at least in part;
being performed on the client's behalf by the provider;
allows the client to change the client's user profile.

12. The system of claim 1 wherein the second computing means allows the client to fill out a questionnaire eliciting information regarding the nature of the services appropriate for the client.

13. The apparatus of claim 12 wherein the questionnaire contains means to permit the client to pay for the services performed on the client's behalf.

14. The system of claim 13 wherein a third party, other than the client and the provider, facilitates the payment of the services.

15. The system of claim 12 wherein the client's inputting information into the questionnaire provokes an e-mail message to the provider alerting the provider that an entity wishes to have services performed on the entity's behalf.

16. The system of claim 12 wherein the services are the formation and organization of a corporation, and the questionnaire elicits information concerning at least one of the following:
a corporate name reservation;
an intended business for the corporation;
authorized share capital;
identification of shareholders;
identification of directors and officers; and
an accounting reference date.

17. The system of claim 12 further comprising means for the client to accept the law of a certain jurisdiction before the questionnaire is forwarded to the provider.

18. The system of claim 1 wherein the provision of services is the provision of legal services, and the legal services can be performed according to the laws of several jurisdictions.

19. The system of claim 1 wherein the provider uses the third computing means to gather and store information relevant to the provision of the services.

20. A method for providing services to clients via computer. said method comprising:
permitting a potential client to have access to a first computing means to enable said potential client to register with a provider of the services;
providing a second computing means, coupled to the first computing means, to facilitate a client's access to the services, wherein the second computing means is partitioned into a plurality of private areas, each private area dedicated to single client, other clients not being granted access to said private area; and
allocating a third computing means, coupled to the first computing means and to the second computing means, to the provider, wherein the provider has access to the third computing means but the clients do not.

21. The method of claim 20 wherein the services are legal services.

22. The method of claim 20 wherein the second computing means and the third computing means are part of the same computer.

23. The method of claim 20 wherein the client accesses the first computing means in an on-line manner.

24. The method of claim 23 wherein the client accesses the first computing means via an open network.

25. The method of claim 20 wherein the client accesses the first computing means in an off-line manner.

26. The method of claim 20 wherein the client is remote from at least one of said computing means.

27. The method of claim 20 wherein the provision of services is the formation and organization of a corporation.

28. The method of claim 27 wherein the incorporation is formed according to the laws of Bermuda.

29. the method of claim 20 wherein the first computing means performs at least one of the following functions;
gives answers to frequently asked questions;
allows the client to register with the provider;
allows the client to log into the second computing means;
gives the client a demonstration of the computerized provision of services;
allows the client to learn more about the computerized provision of services;
allows the client to download a registration questionnaire;
allows the client to send an e-mail to the provider.

30. The method of claim 20 wherein the second computing means performs at least one of the following functions:
allows the client to fill out a registration questionnaire at least in part;
allows the client to determine the status of the work being performed on the client's behalf by the provider;
allows the client to change the client's user profile.

31. The method of claim 20 wherein the second computing means allows the client to fill out a questionnaire eliciting information regarding th nature of the services appropriate for the client.

32. The method of claim 31 wherein the questionnaire contains means to permit the client to pay for the services performed on the client's behalf.

33. The method of claim 32 wherein a third party, other than the client and the provider, facilitates the payment of the services.

34. The method of claim 31 wherein the client's inputting information into the questionnaire provides an e-mail message to the provider alerting the provider that an entity wishes to have services performed on the entity'behalf.

35. The method of claim 31 wherein the services are the formation and organization of a corporation, and the questionnaire elicits information concerning at least one of the following:
a corporate name reservation;
an intended business for the corporation;
authorized share capital;
identification of shareholders;
identification of directors and officers; and an accounting reference date.

36. The method of claim 31 further comprising means for the client to accept the law of a certain jurisdiction before the questionnaire is forwarded to the provider.

37. The method of claim 20 wherein the provision of services is the provision of legal services, and the legal services can be performed according to the laws of several jurisdictions.

38. The method of claim 20 wherein the provider uses the third computing means to gather and store information relevant to the provision of the services.

39. A computer readable medium containing computer executable instructions for enabling a provider to provide services to clients, said instructions comprising:
allowing a potential client to obtain access to a first allowing a client to obtain access to a second computing means, coupled to the first computing means, to receive the services, wherein the second computing means is partitioned into a plurality of private areas, each private area being dedicated to a single client, other clients not being granted access to said private area; wherein:
a third computing means is coupled to the first computing means and to the second computing means and is an area to which the provider has access but the clients do not have access.
